(19) United States
(12) Patent Application Publication
(10) Pub. No.: US 2013/0017311 A1
(43) Pub. Date: Jan. 17, 2013

(54) FLUORESCENT CANDIES

(71) Applicant: Jose Luis Nolasco, Denver, CO (US)

(72) Inventor: Jose Luis Nolasco, Denver, CO (US)

(21) Appl. No.: 13/549,674

(22) Filed: Jul. 16, 2012

Related U.S. Application Data
(60) Provisional application No. 61/508,369, filed on Jul. 15, 2011.

(51) Int. Cl. A23G 3/36; A23G 3/48

(52) U.S. Cl. 426/660

(57) ABSTRACT

A unique fluorescent candy product that glows under a black light (ultraviolet light) comprises riboflavin, granulated sugar; and corn syrup. Riboflavin, also known as vitamin B2, is a non-toxic substance having a neutral flavor and a bright yellow color, and will glow under a black light. Riboflavin works best when incorporated into clear candies and confections such as hard candies, gummies, and gels.

### REFERENCE TO RELATED APPLICATIONS

This patent application claims the benefit of U.S. Provisional Application No. 61/508,369 filed on Jul. 15, 2011, the disclosure of which is incorporated herein by reference in its entirety.

### BACKGROUND OF THE INVENTION

1. Field of the Invention

The present invention relates to novel candies and confections, and more particularly to fluorescent candies and confections that glow under a black light.

2. Description of Related Art

It has become popular in recent years to use tonic water to make drinks or jello that glow under a black light (ultraviolet light) in order to add thrill and promote atmosphere to a party or gathering. The component in tonic water responsible for the fluorescent properties is quinine which has a bitter flavor.

Riboflavin is a non-toxic, water soluble vitamin. It has a yellow color and glows brightly under a black light. The advantage of using riboflavin as opposed to quinine is that riboflavin has a neutral flavor. It is not bitter and thus it is ideal to be used in candies and confections so they can glow under a black light. But currently, riboflavin is not used for such a purpose in candies or confections.

Currently, there are no candies that can glow under a black light available in the market place. It is desirable to have another type of candies and confections that can provide excitement and promote ambiance in a birthday party or Halloween party or any kind of celebrations. Candies and confections that incorporate riboflavin and/or other edible fluorescent substances which will glow under a black light are therefore desirable.

### SUMMARY OF THE INVENTION

It is an object of the invention to provide candies and confections that has fluorescent property so it will glow under a black light.

It is another object of the invention to provide candies and confections that have a neutral flavor.

It is a further object of the invention to provide candies and confections that is non-toxic.

Riboflavin is a non-toxic, water soluble vitamin. It is also known as vitamin B. It has a yellow color and glows brightly under a black light. If incorporated properly into a hard candy or confection, it will give that candy fluorescent properties and thus the candy will glow under a black light. Riboflavin is a desired candidate to be added to the candies because it has a neutral flavor. Unlike quinine which has a bitter flavor, riboflavin is not bitter and thus it will please to young kids if incorporated in candies.

The confections or hard candies according to the present invention comprise riboflavin, granulated sugar, corn syrup, and water. Riboflavin works best when incorporated into clear candies and confections such as hard candies, gummies, and gels. Various types of food additives including fruit flavor, coloring, salts, edible acids, etc. may be added to the candy composition. Flavoring agents may be added to impart flavor of the candy. Fruit juice or fruit particles may be randomly dispersed throughout the substrate.

In other embodiments, other food grade fluorescent substances may also be added to the candies to impart the fluorescent character to candies, including quinine, chlorophyll, and some natural product extracts, etc.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE PREFERRED EMBODIMENT

Other aspects, features, and advantages of the present invention will become more fully apparent from the following detailed description, the appended claim, and the accompanying drawings in which similar elements are given similar reference numerals.

In accordance with the present invention, a unique candy product has been provided with a fluorescent property that glows under a black light. The present fluorescent candy may comprise 40-80% by weight of granulated sugar; 20-60% by weight of corn syrup; 0.005-0.1% by weight of riboflavin; and trace amount of water as shown in Table 1. The preferred composition of the fluorescent candy comprises about 60% by weight of said granulated sugar; 40% by weight of said corn syrup and 0.015% by weight of riboflavin as shown in Table 1.

TABLE 1

| Ingredients | % by Weight Range | Preferred % by Weight |
|---|---|---|
| Granulated Sugar | 40-80 | 60 |
| Corn Syrup | 20-60 | 40 |
| Water | trace | trace |
| Riboflavin | 0.005-0.1 | 0.015 |

Riboflavin, also known as vitamin B2, is a non-toxic substance having a neutral flavor and a bright yellow color, and will glow under a black light. Riboflavin works best when incorporated into clear candies and confections such as hard candies, gummies, and gels. The candy composition may further comprise one or more food additive selected from flavorings, colorings, and salt. Flavoring agents may be added to the fluorescent candy product to impart the desired flavor. For this purpose, natural fruit juice concentrate or artificial flavoring may be added to the candy. Various food grade organic acids selected from the group of citric acid, isocitric acid, maleic acid, fumaric acid, succinic acid, adipic acid, malic acid, and tartaric acid may be added to the candy to impart a tart taste to the product.

In other embodiments, other food grade fluorescent materials may also be added to the candy to impart the fluorescent character to the candy, including quinine, chlorophyll, etc. Although quinine may give a bitter taste it may be welcome by certain customers. Chlorophyll glows blood red under a black light. The candy of the present invention may comprise natural product extracts that contain fluorescent materials.

The following example is directed to a recipe (formulation) of the preferred embodiment of the present invention and is submitted for illustrative purposes only. The example is not to be construed as limiting the scope of the invention set forth in the claims forming a part of the present application. The formulation of such example is set forth in the Table 3 below.

### EXAMPLE

A fluorescent candy composition for a batch can be prepared using the following ingredients:

TABLE 2

| Ingredients | Preferred Quantity |
|---|---|
| Granulated Sugar | 392 gm |
| Corn Syrup | 273 gm |
| Water (to be evaporated) | 118 gm |
| Riboflavin | 100 mg |

The process for preparing the fluorescent candy product comprising steps of weighing and dissolving approximately 100 mg of riboflavin in approximately 118 gm of water in a sauce pan; weighing and adding approximately 392 gm of granulated sugar and 273 gm of corn syrup into said water and combining all ingredients in said sauce pan to make a candy mixture; cooking the candy mixture over medium heat to hard crack stage which is about 310 degrees Fahrenheit at sea level (adjust the temperature for elevation if necessary); and pouring the candy mixture into molds and let set and cool. Before pouring the candy mixture into molds and let set and cool, ensure that there are no un-dissolved sugar crystals during cook. This can be done by following common candy cooking practices. Most of water is evaporated during the cooking process. The composition of the fluorescent candy in a batch can be scaled up or scaled down.

The resulting fluorescent candy in a batch may contain the composition illustrated in Table 3 below:

TABLE 3

| | | Preferred % by |
|---|---|---|
| Ingredients | Preferred Quantity | Weight |
| Granulated Sugar | about 392 gm | about 60 |
| Corn Syrup | about 273 gm | about 40 |
| Water | Trace amount | Trace amount |
| Riboflavin | about 100 mg | about 0.015 |

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A fluorescent candy composition comprising edible substance that glows brightly from fluorescence under a black light; granulated sugar; and corn syrup.

2. The fluorescent candy composition of claim 1 wherein the edible substance that glows brightly including riboflavin.

3. The fluorescent candy composition of claim 1 wherein the edible substance that glows brightly including quinine.

4. The fluorescent candy composition of claim 1 wherein the edible substance that glows brightly including chlorophyll.

5. The fluorescent candy composition of claim 2, wherein said riboflavin is present in an amount of 0.005-0.1% by weight, said granulated sugar is present in an amount of 40-80% by weight, and said corn syrup is present in an amount of 20-60% by weight.

6. The fluorescent candy composition of claim 2, wherein said riboflavin is preferably present in an amount of about 0.015% by weight, said granulated sugar is preferably present in an amount of about 60% by weight, and said corn syrup is preferably in an amount of about 40% by weight.

7. The fluorescent candy composition of claim 5 further comprising at least one food additive selected from flavorings, colorings, and salts, and edible acids.

8. The fluorescent candy composition of claim 7 wherein the edible acids are selected from the group consisting of citric acid, isocitric acid, maleic acid, fumaric acid, succinic acid, adipic acid, malic acid, tartaric acid, and any combinations thereof.

9. The fluorescent candy composition of claim 5 further comprises fruit juice or fruit particles.

10. The fluorescent candy composition of claim 6 further comprising at least one food additive selected from flavorings, colorings, and salts, and edible acids.

11. The fluorescent candy composition of claim 10 wherein the edible acids are selected from the group consisting of citric acid, isocitric acid, maleic acid, fumaric acid, succinic acid, adipic acid, malic acid, tartaric acid, and any combinations thereof.

12. The fluorescent candy composition of claim 2 wherein riboflavin works best when incorporated into clear candies and confections such as hard candies, gummies, and gels.

13. A fluorescent candy composition comprising 0.005-0.1% by weight of riboflavin, 40-80% by weight of granulated sugar, and 20-60% by weight of corn syrup.

13. The fluorescent candy composition of claim 13 wherein said riboflavin is preferably present in an amount of about 0.015% by weight, said granulated sugar is preferably present in an amount of about 60% by weight, and said corn syrup is preferably in an amount of about 40% by weight.

14. The fluorescent candy composition of claim 12 further comprising at least one food additive selected from flavorings, colorings, and salts, and edible acids.

15. The fluorescent candy composition of claim 14 wherein the edible acids are selected from the group consisting of citric acid, isocitric acid, maleic acid, fumaric acid, succinic acid, adipic acid, malic acid, tartaric acid, and any combinations thereof.

16. The fluorescent candy composition of claim 13 further comprises fruit juice or fruit particles.
